(19) United States
(12) Patent Application Publication
(10) Pub. No.: US 2019/0257182 A1
(43) Pub. Date: Aug. 22, 2019

(54) Oil Recovery Method

(71) Applicant: BP Exploration Operating Company Limited, Middlesex (GB)

(72) Inventors: John William Couves, Bourne End, Buckinghamshire (GB); Piotr Krawiec, London (GB); Bilal Rashid, London (GB); Timothy Stephen Totton, Isleworth (GB)

(73) Assignee: BP Exploration Operating Company Limited, Middlesex (GB)

(21) Appl. No.: 16/348,132

(22) PCT Filed: Nov. 6, 2017
(86) PCT No.: PCT/EP2017/078366

§ 371 Date: May 7, 2019

(30) Foreign Application Priority Data
Nov. 23, 2016 (EP) 16200332.1

(51) Int. Cl. E21B 43/20; G05B 13/04; E21B 49/00

(52) U.S. Cl. CPC E21B 43/20; C09K 8/58; E21B 49/003; G05B 13/048

(57) ABSTRACT

A method for selecting an aqueous displacement fluid comprising an aqueous solution of dissolved phosphate species includes obtaining reservoir parameters for a reservoir, receiving an input comprising a permitted loss of dissolved phosphate species resulting from mixing of the aqueous displacement fluid and resident water following injection of a selected pore volume of the aqueous displacement fluid, selecting an aqueous displacement fluid, and determining that a composition of the aqueous displacement fluid is within an operating envelope using the reservoir parameters and the permitted loss of dissolved phosphate species. The reservoir parameters include physical characteristics of the reservoir and chemical characteristics of the resident water. The operating envelope defines boundary conditions for one or more parameters of the composition of the aqueous displacement fluid to limit a loss of dissolved phosphate species upon injection into the reservoir to less than or equal to the permitted loss.

### CROSS-REFERENCE TO RELATED APPLICATIONS

This application is a 35 U.S.C. § 371 national stage application of PCT/EP2017/078366 filed Nov. 6, 2017 and entitled “Oil Recover Method,” which claims priority to European Application No. 16200332.1 filed Nov. 23, 2016 and entitled “Oil Recovery Method,” both of which are hereby incorporated herein by reference in their entirety for all purposes.

### STATEMENT REGARDING FEDERALLY SPONSORED RESEARCH OR DEVELOPMENT

Not applicable.

### BACKGROUND

Water-flooding is one of the most successful and extensively used secondary recovery methods for recovering additional oil from a reservoir. Water is typically injected, under pressure, into reservoir rocks via injection wells, driving the oil through the rock towards production wells.

U.S. Pat. No. 3,191,676 relates to adding phosphates to a flooding water for a carbonate reservoir to improve oil recovery therefrom. It is said that the presence of phosphates in a flooding water increases the amount of oil which can be recovered from a core. However, strong adsorption of phosphate on the carbonate rock surfaces causes loss of the phosphate before it has travelled more than a few feet from the injection well. U.S. Pat. No. 3,191,676 involves using water-soluble carbonates of the alkali metals or ammonium in combination with phosphates in order to reduce loss of phosphates. The tests described in this patent are said to establish the ability of water-soluble carbonate to decrease the loss of phosphate to a limestone formation and, the effectiveness of the phosphate in the presence of the carbonate to displace more oil than the carbonate alone. However, it is said that the limitation to carbonate-containing formations imposes some limitations on the pH of the flooding water as limestone is capable of neutralizing acids. Thus, it is deemed impractical to maintain a flooding water pH below 6 such that the pH is preferably within the range between about 8 and 11.

U.S. Pat. No. 3,258,071 relates to a process of recovering hydrocarbons from a subterranean, oil-wet formation containing hydrocarbons by means of a waterflooding operation the improvement of which comprises injecting into the oil-wet formation a waterflooding medium having a pH in the range of about 5 to 9 and containing an amount of alkali trimetaphosphate sufficient to change the oil-wet formation to a water-wet formation by passage of the medium through the formation. It is said that water flood media containing an alkali trimetaphosphate are considerably more beneficial than water flood media containing sodium tripolyphosphate in the water flooding of relatively deep reservoirs wherein the temperature of the water will increase to 100° F. (37.8° C.) or more. Under such conditions the sodium tripolyphosphate in the water floods degrades or hydrolyses to less beneficial, and often harmful, orthophosphates, whereas the alkali trimetaphosphate in the injection water is converted or hydrolyzed to alkali tripolyphosphate. This means that when trimetaphosphate is used, part of it is in solution functioning to make an oil-wet formation water-wet, part of it is being hydrolyzed to tripolyphosphate which acts to sequester metal ions being picked up as the water flood moves through a formation and only a small part is being converted to orthophosphate at any point in time. Both the alkali trimetaphosphate used and tripolyphosphate, to which it is converted during use, are thought to be beneficial ingredients in the water flood medium. Orthophosphates are deemed harmful as these form precipitates with calcium, magnesium and iron ions that often cause restriction of flow and plugging of injection and producing wells or of the oil bearing formation. U.S. Pat. No. 3,258,071 does not teach any boundary conditions under which precipitation of orthophosphates is reduced such that the orthophosphates improve the yield of oil recovered from a sandstone reservoir.

International patent application publication number WO 2007/089474 relates to an additive for secondary oil recovery that includes an inorganic phosphorus and nitrogen containing parent solution containing [Y]H₂PO₄ and [Y]₂HPO₄, where [Y] is a cation. It is said that the additive may be dispersed within an injection water and that by manipulating the ratios of the H₂PO₄⁻ and HPO₄²⁻ ions, the solution can be created in a preferred pH range of about 6.0 to about 8.0. However, WO 2007/089474 is silent concerning whether the additive is intended for use in a carbonate or sandstone reservoir.

### BRIEF SUMMARY OF THE DISCLOSURE

In some aspects, a computer-implemented method for determining a composition of an aqueous displacement fluid for injection into a subterranean reservoir comprising at least one layer of a porous and permeable reservoir rock having crude oil and a resident water in a pore space thereof includes modelling a plurality of mixtures formed by mixing of each of a plurality of aqueous displacement fluids with one or more resident water compositions for one or more reservoirs, generating data indicative of losses of dissolved phosphate species in each mixture of the plurality of mixtures wherein the losses are determined using one or more physical characteristics of the one or more reservoirs, determining one or more correlations between (i) the losses of dissolved phosphate species and (ii) chemical characteristics of the aqueous displacement fluid, chemical characteristics of the one or more resident water compositions, and the one or more physical characteristics of the one or more reservoirs, determining a predictive expression for losses of dissolved phosphate species based on the one or more correlations, and determining boundary values for the chemical characteristics of the aqueous displacement fluid for selected chemical characteristics of the one or more resident water compositions and selected physical characteristics of the reservoir using the predictive expression. Each aqueous displacement fluid comprises an aqueous solution comprising dissolved phosphate species, and the one or more resident water compositions comprise at least one water-soluble precursor cation species for insoluble phosphate species. The one or more reservoirs have the one or more physical characteristics.

In some aspects, a method for selecting an aqueous displacement fluid comprising an aqueous solution of dissolved phosphate species includes obtaining one or more reservoir parameters for a reservoir, receiving an input comprising a permitted loss of dissolved phosphate species resulting from mixing of the aqueous displacement fluid and resident water within the reservoir following injection of a selected pore volume of the aqueous displacement fluid into the reservoir, selecting an aqueous displacement fluid, and determining that a composition of the aqueous displacement fluid is within an operating envelope using one or more inputs comprising the one or more reservoir parameters and the permitted loss of dissolved phosphate species. The reservoir comprises a porous and permeable rock having crude oil and a resident water in a pore space thereof, and the reservoir parameters comprise physical characteristics of the reservoir and chemical characteristics of the resident water. The operating envelope defines boundary conditions for one or more parameters of the composition of the aqueous displacement fluid to limit a loss of dissolved phosphate species through precipitation of insoluble phosphate species from the aqueous displacement fluid upon injection of the selected pore volume of aqueous displacement fluid into the reservoir to less than or equal to the permitted loss of dissolved phosphate species.

In some aspects, a method of injecting a fluid comprises injecting an aqueous displacement fluid into a subterranean reservoir, and limiting precipitation of the dissolved phosphate species upon mixing of the aqueous displacement fluid with the resident water within the subterranean reservoir to less than or equal to a predetermined amount. The subterranean reservoir comprises a porous and permeable rock having crude oil and a resident water in a pore space thereof, and the resident water comprising a multivalent cation species. The resident water has a pH and a multivalent cation concentration, and the subterranean formation has a dispersivity. The aqueous displacement fluid comprises an initial multivalent cation concentration, and an initial additive concentration of dissolved phosphate species normalized to one pore volume. A percentage of precipitation of the dissolved phosphate species arising from precipitation of insoluble phosphate species, after injection of from 0.3 to 0.7 pore volumes of aqueous displacement fluid, can be defined, in some instances, by:

$$\frac{( \begin{matrix}( \begin{matrix}( a * ( DL ) + d ) + b * \\ ( PC + f ) * ( DC + e ) * \\ {( i * DP [ \% ] + j )}^{c}\end{matrix} ) * \\ AC * WD ( x + k , l )\end{matrix} )}{g * ( AC + h )}$$

where DL is the multivalent cation concentration of the aqueous displacement fluid in units of (mg/kg of water), PC is the pH of the resident water, DC is the multivalent cation concentration of the resident water in units of (mg/kg of water), DP is a dispersivity of the subterranean formation in units of (%), AC is the initial concentration of the dissolved phosphate species normalized to one pore volume, and WD is a Weibull function of a parameter x, wherein x is the valency of the average formula [H₃₋ₓPO₄]^{x-} for the monophosphate anions or the number of missing hydrogens in the average formula [H₃₋ₓPO₄]^{x-}, wherein a has a value of 0.002164, b has a value of 0.000023699, c has a value of 0.3, d has a value of 901.43, e has a value of 34490.0,f has a value of 25.378, g has a value of 0.64178, h has a value of -404.297, i has a value of 0.083218, j has a value of −0.0041599, k has a value of −1, and / has a value of 1.5.

These and other features will be more clearly understood from the following detailed description taken in conjunction with the accompanying drawings and claims.

### BRIEF DESCRIPTION OF THE DRAWINGS

For a detailed description of the preferred embodiments of the invention, reference will now be made to the accompanying drawings in which:

FIG. 1 is a schematic, cross-sectional illustration of an oil recovery system and a reservoir in respect of which embodiments of the invention are applicable.

FIG. 2 is a schematic representation of a computer system suitable for carrying out various embodiments.

FIG. 3 is a schematic representation of an embodiment of a modeled injection system.

FIG. 4 is a schematic representation of mixing experiments.

### DETAILED DESCRIPTION OF THE PREFERRED EMBODIMENTS

“Resident water” is defined herein as formation water or a mixture of formationwater and any previously injected water or invading aquifer water wherein “formation water” is the initial water trapped within the pore space of a reservoir rock.

“Inorganic phosphate salt” is defined herein as meaning any water-soluble inorganic phosphate salt including water-soluble monophosphate salts (also referred to in the art as “orthophosphate salts”) and water-soluble polyphosphate salts.

“Inorganic phosphoric acid” is defined herein as meaning any water-soluble phosphoric acid including water soluble monophosphoric acid (also referred to in the art as “orthophosphoric acid”) and water-soluble polyphosphoric acids.

“Dissolved phosphate species” is defined herein as meaning dissolved water-soluble monophosphate anions (also referred to in the art as orthophosphate anions) or dissolved water-soluble polyphosphate anions. The monophosphate anions may arise from a water-soluble inorganic monophosphate salt (orthophosphate salt) or from monophosphoric acid (orthophosphoric acid). The polyphosphate anions may arise from a water-soluble inorganic polyphosphate salt or a polyphosphoric acid. The polyphosphate anions undergo hydrolysis to generate monophosphate anions and may be regarded as precursors of monophosphate anions.

The parameter x for the aqueous displacement fluid is defined herein as either the valency of the average formula for the monophosphate anions [H₃₋ₓP)₄]^{x-} (assuming the dissolved monophosphate species are fully dissociated into their respective monovalent cations and monophosphate anions) or the number of missing hydrogens in the average formula [H₃₋ₓPO₄]^{x-}. Accordingly, the value for x is a number in the range of 0 to 3. Where the monophosphate anions are derived from polyphosphate anions, the x parameter is determined after complete hydrolysis of the polyphosphate anions.

“Precipitate precursor cations” is defined herein as cations that react with dissolved phosphate species to form insoluble phosphate species.

The present invention relates to a method for recovering crude oil from an oil-bearing reservoir comprising injecting into the reservoir an aqueous displacement fluid comprising an aqueous solution of dissolved phosphate species where the aqueous displacement fluid undergoes mixing with the resident water of the reservoir at the front of the injected aqueous displacement fluid, and where a model is used to define boundary values for the chemical characteristics of the aqueous displacement fluid which, if obeyed, inhibit loss of dissolved phosphate species through precipitation of insoluble phosphate species upon dispersive mixing of the aqueous displacement water with the resident water. The resulting boundary values can define an operating envelope for the aqueous displacement fluid used for injection into the formation.

A problem arises upon injecting an aqueous displacement fluid comprising dissolved monophosphate species into a reservoir comprising at least one layer of reservoir rock having crude oil and a resident water contained within the pore space thereof if the resident water comprises dissolved precipitate precursor cations in that there is a risk of precipitation of insoluble phosphate species upon reaction of dissolved phosphate species with the dissolved precipitate precursor cations upon dispersive mixing of the aqueous displacement fluid with the resident water of the reservoir. Precipitation of insoluble phosphate species may result in the concentration of dissolved phosphate species in the dispersively mixed fluids falling to below a threshold level for achieving incremental oil recovery from the reservoir. In addition, precipitation of insoluble phosphate species may result in formation damage.

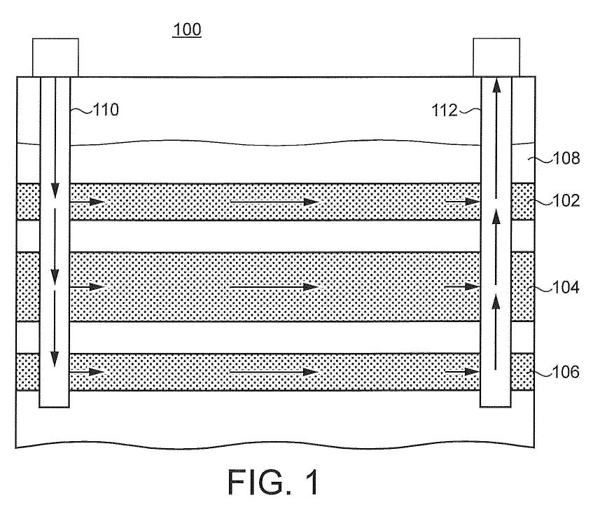

FIG. 1 illustrates a crude oil recovery system 100. Within the system 100, a reservoir is present comprising at least one layer of reservoir rock. In this example, the reservoir comprises a plurality of layers of reservoir rock 102, 104 and 106. Above the top layer 106 are shown generalized surface layers 108 which may comprise multiple, non-oil bearing layers, and (if the reservoir is offshore) a layer of seawater. The composition of these layers can vary.

Penetrating the reservoir is an injection well 110; and a production well 112. Typically, there are many more wells than the two shown here; however, two are shown in this exemplary embodiment for simplicity. The injection wells shown here are vertical wells. In alternative systems, the wells may be deviated at any suitable angle, horizontal, and/or curved.

In general, an aqueous displacement fluid can be injected into the layers of reservoir rock 102, 104 and 106 from the injection wel1110 (as shown by the arrows) to improve oil recovery, optionally followed by a quantity of drive water to displace the aqueous displacement fluid through the reservoir towards the production well 112 from which the oil is recovered (again shown by the arrows). As described in more detail herein, the aqueous displacement fluid can comprise dissolved phosphate species to improve the oil recovery. Further, the subterranean reservoir can comprise a resident water that can contain precipitate precursor cations, which can lead to precipitation of insoluble phosphate species upon mixing of the aqueous displacement fluid with the resident water, thereby reducing the concentration of dissolved phosphate species available for enhancing the oil recovery. In addition, mixing of the aqueous displacement fluid comprising dissolved phosphate species with a drive water comprising precipitate precursor cations can also result in precipitation of the insoluble phosphate species.

In order to address the precipitation of the insoluble phosphate species, boundary values for properties of the aqueous displacement fluid can be determined. In some aspects, a method can comprise determining boundary values for the chemical characteristics of an aqueous displacement fluid for injection into a reservoir comprising at least one layer of a reservoir rock having crude oil and a resident water contained within the pore space thereof. The aqueous displacement fluid can comprise an aqueous solution comprising dissolved monophosphate anions having an average formula [H₃₋ₓPO₄]^{x-}, where x represents an average number of missing hydrogens (or the valency of the average formula [H₃₋ₓPO₄]^{x-}) and can be any number in the range of 0 to 3. For example, a number of monophosphate species can be in solution, depending on the pH, including H₃PO₄ (e.g., x=0), H₂PO₄⁻ (e.g., x=1), HPO₄²⁻ (e.g., x=2) and PO₄³⁻ (e.g., x=3) and the average value of hydrogens in the monophosphate anions, 3-x, can represent the average of the monophosphate species within the aqueous displacement fluid. The resident water can comprise at least one precipitate precursor cation for insoluble phosphate species, typically a mixture of precipitate precursor cations. Mixing of the aqueous displacement fluid with the resident water of the reservoir can result in loss of dissolved phosphate species from the mixed fluids through reaction of dissolved monophosphate anions with dissolved precipitate precursor cations, which can result in precipitation of insoluble phosphate species.

The boundary values used to determine the chemical characteristics of the aqueous displacement fluid can be determined in a number of ways. In some aspects, the boundary values for the chemical characteristics of the aqueous displacement fluid are determined by generating, using a geochemical model comprising a mixing module, speciation module, and a precipitation module, losses of dissolved phosphate species arising from mixing different combinations of one of a plurality of different aqueous displacement fluids and one of a plurality of different resident waters under a plurality of different reservoir conditions. The input data can be inputted into the geochemical model, which can include chemical characteristics of each of the plurality of different aqueous displacement fluids including, but not limited to, pH, concentrations of water-soluble inorganic phosphate salt(s) and/or water-soluble phosphoric acid(s), the concentrations of any additional water-soluble salts selected from salts of monovalent and multivalent cations, and any combination thereof. The geochemical model assumes any water-soluble inorganic polyphosphate salt or polyphosphoric acid inputted into the model undergoes rapid hydrolysis to generate monophosphate anions. The input data can also include chemical characteristics of each of the plurality of different resident waters including, but not limited to, pH and the concentration of water-soluble salt(s) of precipitate precursor cation(s) and the concentrations of any additional dissolved salts selected from salts of monovalent cations. The person skilled in the art will understand that the concentrations inputted into the geochemical model are initial concentrations. The input data can also include physical characteristics of a plurality of different reservoirs including, but not limited to, reservoir dispersivity and/or reservoir temperature. For each combination of aqueous displacement fluid and resident water, the geochemical model can execute a plurality of simulations by mixing the fluids in the mixing module using a plurality of different injected pore volumes of aqueous displacement fluid and using the physical characteristics of the plurality of different reservoirs, and for each simulation, the speciation module and precipitation module calculate the loss of dissolved phosphate species for the resulting mixed fluids.

The method can further include inputting into a statistical model, for each of the plurality of simulations, first input data comprising the calculated losses of dissolved phosphate species and second input data comprising the chemical characteristics of the aqueous displacement fluid, the chemical characteristics of the resident water, the physical characteristics of the reservoir and the injected pore volumes of aqueous displacement fluid. Correlations between the first and second input data can be generated and outputted and a predictive expression for the maximum permitted loss of dissolved monophosphate species can be generated based on the correlations.

The correlations can provide an identification of the variables that have the greatest effect on the loss of dissolved phosphate species through precipitation of the insoluble phosphate species upon mixing of the aqueous displacement fluid comprising the dissolved phosphate species with the resident water comprising the precipitating cations. It has been found that the x parameter for the aqueous displacement fluid as defined herein (e.g., the missing hydrogens in the average formula for the monophosphate species, [H₃₋ₓPO₄]^{x-}), can have the greatest impact on the precipitation of the insoluble phosphate species upon mixing of an aqueous displacement fluid with a resident water and may be included in a predictive expression. Since the pH of the aqueous displacement fluid and the x parameter are correlated, the pH of the aqueous displacement fluid can also have an effect on the precipitation of insoluble phosphate species upon mixing of an aqueous displacement fluid comprising dissolved phosphate species with a resident water comprising precipitating cations. Accordingly, pH may be included in a predictive expression as an alternate to the x parameter or in addition to the x parameter. The dispersivity of the reservoir and initial concentration of dissolved phosphate species in the aqueous displacement fluid can also be correlated with the precipitation of the insoluble phosphate species and can also be included in a predictive expression. If desired, additional variables and parameters can also be correlated and included in a predictive expression including the initial multivalent cation concentration of the aqueous displacement fluid, concentrations of individual multivalent cations in the aqueous displacement fluid, pH of the resident water, the multivalent cation concentration of the resident water, divalent cation concentration or the resident water and concentrations of individual multivalent cations (typically, divalent cations and trivalent cations) in the resident water.

In some aspects, a predictive expression can be developed based on the x parameter. Alternatively, a predictive expression can be based on the pH of the aqueous displacement fluid as the pH is related to the x parameter. Thus, a predictive expression relating the losses of dissolved monophosphate species in the aqueous displacement fluid can be based on the x parameter and/or the pH of the aqueous displacement fluid along with one or more chemical characteristics of the resident water, one or more physical characteristics of the reservoir, and the injected pore volume(s) of the aqueous displacement fluid. In some aspects, the predictive expression can also take the dispersivity of the reservoir and/or the initial concentration of dissolved monophosphate species in the aqueous displacement fluid into account.

While a variety of predictive expressions can be used, one such expression for the percentage of dissolved phosphate species lost due to mixing can include:

$$\% of phosphate lost = \frac{( \begin{matrix}( \begin{matrix}( a * ( DL ) + d ) + b * \\ ( PC + f ) * ( DC + e ) * \\ {( i * DP [ \% ] + j )}^{c}\end{matrix} ) * \\ AC * WD ( x + k , l )\end{matrix} )}{g * ( AC + h )} \qquad ( Eq . 1 )$$

where DL is the multivalent cation concentration of the aqueous displacement fluid in units of (mg/kg of water), PC is the pH of the resident water, DC is the multivalent cation concentration of the resident water in units of (mg/kg water), DP is dispersivity of the reservoir in (%), AC is the initial concentration of monophosphate species normalized to one pore volume (1 PV), and WD is a Weibull function of the x parameter. The initial concentration of dissolved monophosphate species in one pore volume (e.g., AC in Eq. 1) represents an additive amount that is normalized to one pore volume, regardless of the actual pore volume used for the aqueous displacement fluid. The constants a through g in Eq. 1 represent best fit constants determined using the statistical model.

Suitably, Eq. 1 is applicable across a range of injected pore volumes of the aqueous displacement fluid of from 0.3 to 0.7, in particular, 0.4 to 0.6, for example, about 0.5.

The Weibull function can be used to linearize the response to a parameter, for example, parameter x and can be represented by the equation:

$$f ( x ; λ , k ) = \{ \begin{matrix}\frac{k}{λ} {( \frac{x}{λ} )}^{k - 1} {e}^{- {( x / λ )}^{k}} , & x \geq 0 \\ 0 , & x < 0\end{matrix} \qquad ( Eq . 2 )$$

In some aspects, the value of k in the Weibull function can be 1.

The values of the constants in Eq. 1 can be determined using the methods described herein. In some embodiments, the values of the constants can be: a has a value of 0.002164, b has a value of 0.000023699, c has a value of 0.3, d has a value of 901.43, e has a value of 34490.0, f has a value of 25.378, g has a value of 0.64178, h has a value of −404.297, i has a value of 0.083218, j has a value of -0.0041599, k has a value of -1, and 1 has a value of 1.5. These values are exemplary and other constants can be used and determined depending on the available data for determining the correlations.

In some aspects, the x parameter can be replaced by the pH of the aqueous displacement fluid to obtain a similar expression for the amount of phosphate species lost. In an embodiment, an expression for the percentage of phosphate lost due to mixing that uses the pH of the injected fluid can include:

$$\% of phosphate lost = \frac{( \begin{matrix}( \begin{matrix}( a * ( DL ) + d ) + b * \\ ( PC + f ) * ( DC + e ) * \\ {( i * DP [ \% ] + j )}^{c}\end{matrix} ) * \\ AC * ( pH + k )\end{matrix} )}{g * ( AC + h )} \qquad ( Eq . 3 )$$

where DL, PC, DC, DP, and AC are the same as defined with respect to Eq. 1 and pH is the pH of the aqueous displacement fluid. The constants a through gin Eq. 3 represent best fit constants determined using the statistical model, and may not have the same values as those described with respect to Eq. 1.

The values of the constants in Eq. 3 can be determined using the methods described herein. In some embodiments, the values of the constants can be: a has a value of 0.00893358577866, b has a value of 0.00001873911362, c has a value of 0.3, d has a value of −38.760711942606, e has a value of 36612.4690660208, f has a value of 22.3005918895281, g has a value of 5.70150711512329, h has a value of −511.4406033857, i has a value of 0.14791108670263, j has a value of −0.028208361561 and k has a value of −2.6106766395516. These values are exemplary and other constants can be used and determined depending on the available data for determining the correlations.

Where an aqueous displacement fluid comprising dissolved monophosphate species is being evaluated for use in a selected reservoir, certain parameters within Eq. 1 and/or Eq. 3 can then be fixed. For example, the parameters that can be fixed can represent those having properties that cannot be changed such as the dispersivity of the reservoir and/or the measured chemical characteristics of the resident water (e.g., the pH of the resident water, the multivalent cation concentration of the resident water, the divalent cation concentration of the resident water, etc.). Additional parameters can also be fixed such as the selected injected pore volume of the aqueous displacement fluid and/or a selected permitted level of loss of the dissolved monophosphate species upon mixing the aqueous displacement fluid with the resident water.

The equation (Eq.1 and/or Eq. 3) can then be used to determine boundary values for the remaining variables including the multivalent cation concentration of the aqueous displacement fluid, the initial concentration of dissolved phosphate species, and the value of the x parameter, for the monophosphate species, [H₃₋ₓ PO₄]^{x-}, dissolved in the aqueous displacement fluid. This value is determined for the aqueous displacement fluid prior to mixing of the aqueous displacement fluid with the resident water. In the case of an aqueous displacement fluid that initially comprises a polyphosphate species, the average value for the x parameter for the dissolved phosphate species is determined following complete hydrolysis of the polyphosphate species.

An aqueous displacement fluid can then be selected that is within the boundary values for injection into the reservoir when boundary values exist. In some aspects, the predictive expression in Eq. 1 and/or Eq. 3 may indicate that no boundary values exist, which may identify that an aqueous displacement fluid comprising dissolved phosphate species should not be injected into the reservoir. If boundary values for the chemical characteristics of the aqueous displacement fluid are identified using Eq. 1 and/or Eq. 3, the process can be repeated using Eq. 1 and/or Eq. 3 with different (e.g., lower) permitted levels of loss of dissolved phosphate species and, optionally, for different predetermined injected pore volumes of aqueous displacement fluid in order to improve or optimize the chemical characteristics of the aqueous displacement fluid such that loss of dissolved phosphate species within the reservoir is reduced or minimized.

Where the dissolved phosphate is derived from an inorganic monophosphate salt or from orthophosphoric acid, the initial concentration of dissolved phosphate species is the initial concentration of the dissolved monophosphate salt or dissolved orthophosphoric acid. Where the dissolved phosphate species are derived from a water-soluble inorganic polyphosphate salt or from a water-soluble polyphosphoric acid, the initial concentration of dissolved phosphate species is based on the initial concentration of the dissolved polyphosphate salt or polyphosphoric acid and the number of condensed phosphate, PO₄, units in the polyphosphate anions of the polyphosphate salt or polyphosphoric acid. Where the polyphosphate salt or polyphosphoric acid comprises a mixture of polyphosphate anions having differing numbers of condensed phosphate units, the initial concentration of dissolved phosphate species is based on the initial concentration of the dissolved polyphosphate salt or polyphosphoric acid and the average number of condensed phosphate units in the polyphosphate anions. If the aqueous displacement fluid comprises a mixture of at least one water-soluble monophosphate salt and at least one water-soluble polyphosphate salt, the initial dissolved phosphate concentration is the total concentration of monophosphate anions and condensed phosphate units.

Where an inorganic monophosphate salt having monovalent counter-cations selected from Group IA metal cations, ammonium cations, and optionally hydrogen counter-cations is inputted into the model, the value for the x parameter may be adjusted in the model by changing the inputted pH (for example, by inputting an acid or base into the model). Similarly, in the case of orthophosphoric acid, the value for the x parameter may be adjusted in the model by changing the inputted pH (for example, by inputting an acid or base into the model). Typically, the base that is inputted into the model may be selected from sodium hydroxide, potassium hydroxide and ammonium hydroxide.

Where an inorganic polyphosphate salt having monovalent counter-cations selected from Group IA metal cations, ammonium cations, and optionally hydrogen counter-cations is inputted into the model, the model may assume that hydrolysis of the polyphosphate anions to monophosphate anions occurs rapidly under the modeled reservoir conditions, and the value for the x parameter can therefore be determined for the hydrolysed products (monophosphate species). If desired the value for the x parameter may be adjusted in the model, following hydrolysis, by changing the inputted pH (for example, by inputting an acid or base into the model). Suitable bases for inputting into the model are given above.

In the case of a polyphosphoric acid, the geochemical model may assume that hydrolysis of the polyphosphoric acid to orthophosphoric acid occurs rapidly under reservoir conditions, and the value for the x parameter can be determined for the hydrolysed products (monophosphate species). If desired the value for the x parameter may be adjusted in the model, following hydrolysis, by changing the inputted pH (for example, by inputting an acid or base into the model). Suitable bases for inputting into the model are given above.

Thus, the aqueous displacement fluid selected for injection may comprise an aqueous solution of dissolved monophosphate species having a formula [H₃₋ₓPO₄]^{x-} with a value for the x parameter lying within the defined boundary conditions. The value for the x parameter may be adjusted to lay within the defined boundary conditions by addition of an acid or base to the aqueous displacement fluid, for example, a base selected from sodium hydroxide, potassium hydroxide and ammonium hydroxide.

Typically, the “precipitate precursor cations” in the resident water are multivalent cations including divalent cations and trivalent cations. The divalent cations may be calcium, magnesium, barium, iron, and/or strontium cations. The trivalent cations may be vanadium, aluminum, and/or iron cations.

The term “insoluble phosphate species” is defined herein as meaning insoluble phosphate salts of precipitate precursor cations, such as calcium phosphate and magnesium phosphate, and insoluble minerals comprising phosphate and precipitate precursor cations, such as hydroxyapatite, Ca₅(PO₄)₃OH, chlorapatite, Ca₅(PO₄)₃Cl and bromapatite, Ca₅(PO₄)₃Br, in particular, hydroxyapatite.

The term “dispersivity” of a reservoir is defined herein as the dispersivity in the direction of flow (also referred to as “longitudinal dispersivity”). Longitudinal dispersivity is a characteristic property of reservoir rock arising from velocity differences within pores on a microscopic scale and path differences due to the tortuosity of the pore network of the reservoir rock. Longitudinal dispersivity is related to the dispersion coefficient, D_{L}, of a porous medium and the advective flow velocity, v, of a fluid through the reservoir rock as follows:

D_{L}=α_{L}.v Eq. 4

wherein α_{L} has units of length (typically meters). Longitudinal dispersivity may also be expressed as a dimensionless number, for example, as a percentage of the system length (for example, as a percentage of the length of a core plug, a percentage of the number of grid blocks of a reservoir simulator, a percentage of an interwell distance between a pair of injection and production wells, or, as discussed below, as a percentage of the number of cells of a transportation mixing module of a geochemical model). Alternatively, the dimensionless dispersivity may be defined as a percentage of the distance travelled (for example, as a percentage of the number of grid blocks of a reservoir simulator through which an injection fluid (for example, an aqueous displacement fluid) has been moved, as a percentage of the number of cells of a transportation mixing through which an injection fluid has been shifted, or as a percentage of the distance that an injection fluid has travelled from an injection well to a production well). Typically, the dimensionless dispersivity of a reservoir is in the range of 2% to 10% and dispersive mixing may be modelled in the transportation mixing module of the geochemical model using dispersivities falling within this range. The dispersivity of the reservoir into which the aqueous displacement fluid is to be injected (e.g., as one of the fixed characteristics used to determine the boundary values for the chemical characteristics of the aqueous displacement fluid) may be determined from dispersivity tests performed on samples of a reservoir rock or may be determined from a single well chemical tracer test performed on a well that penetrates an oil-bearing reservoir. When the dispersivity tests are performed on samples of a reservoir rock, typically, the dispersivity tests are performed during coreflood experiments.

The term “reservoir temperature” refers to the temperature of the reservoir beyond any temperature front that exists at a radial distance from one or more injection wells of the reservoir. Typically, the radial distance for the temperature front from the one or more injection wells increases with increasing volume of an injection fluid (for example, an aqueous displacement fluid) injected into a reservoir.

The person skilled in the art will understand that each of the chemical characteristics of one or more of a plurality of different aqueous displacement fluids are independently variable within the geochemical model. The person skilled in the art will understand that each of the chemical characteristics of one or more of a plurality of different resident waters are independently variable within the geochemical model.

A further problem arises when a low pore volume slug of the aqueous displacement fluid is injected into the reservoir (e.g., a slug of aqueous displacement fluid having a pore volume of less than 1, in particular, a slug having a pore volume in the range of 0.3 to 0.9, or having a pore volume in the range of 0.4 to 0.8) followed by injection of a drive water containing dissolved precipitate precursor cations as there is also a risk of precipitation of insoluble phosphate species upon dispersive mixing of the drive water with the aqueous displacement fluid at the rear of the injected slug. The person skilled in the art will understand that the drive water (often referred to as “chase water”) is to be injected into the reservoir to sweep the slug of aqueous displacement fluid towards one or more production wells of the reservoir.

Accordingly, a method can comprise identifying boundary values for a drive water and selecting a drive water satisfying the boundary values using a model. The method can be used in various situation such as when a slug of the aqueous displacement fluid is to be injected into the reservoir having a pore volume of less than 1, in particular, a pore volume in the range of 0.3 to 0.9, preferably, 0.4 to 0.8, followed by injection of a drive water comprising at least one water-soluble salt of a precipitate precursor cation. The method for determining the boundary values for the drive water composition and/or selecting a drive water having a composition within the boundary values can be used alone or in combination with any of the other systems and methods described herein.

In some aspects the method can comprise generating, using the geochemical model, losses of dissolved monophosphate species within the aqueous displacement fluid upon mixing different combinations of one of the plurality of different aqueous displacement fluids and one of a plurality of different drive waters under a plurality of different reservoir conditions. Input data can be inputted into the geochemical model where the input data can comprise (i) chemical characteristics of each of the plurality of different aqueous displacement fluids, as defined herein; (ii) chemical characteristics of each of the plurality of different drive waters comprising pH and the initial concentration of the salt(s) of the precipitate precursor cation(s) and the concentrations of any additional dissolved salts selected from salts of monovalent cations, and physical characteristics of a plurality of different reservoirs, as defined herein. For each combination of aqueous displacement fluid and drive water, the geochemical model may run a plurality of simulations of mixing the fluids in the mixing module using a plurality of different injected pore volumes of drive water and using the physical characteristics of the plurality of different reservoirs. For each simulation, the speciation module and precipitation module can then calculate losses of dissolved monophosphate species for the resulting mixed fluids.

The method can further include inputting into a statistical model, for each of the plurality of simulations, first input data comprising the calculated losses of dissolved monophosphate species and second input data comprising the chemical characteristics of the aqueous displacement fluid, the chemical characteristics of the drive water, the physical characteristics of the reservoir and the injected pore volumes of drive water. Correlations between the first and second input data can be generated and outputted, and a predictive expression for the maximum permitted loss of dissolved monophosphate species can be generated based on the correlations.

The correlations can provide an identification of the variables that have the greatest effect on the precipitation of the dissolved monophosphate species in the aqueous displacement fluid. It has been found that the x parameter can have the greatest impact on the precipitation of the insoluble phosphate species upon mixing of the aqueous displacement fluid with the drive water within the reservoir. Since the pH and the x parameter are correlated, the pH of the aqueous displacement fluid can also have an effect on the precipitation of the insoluble phosphate species upon mixing of the aqueous displacement fluid with the drive water within the reservoir. The dispersivity and initial concentration of dissolved monophosphate species in the aqueous displacement fluid can also be correlated with the precipitation of the phosphate species. These additional variables and parameters can also be correlated and included in a predictive expression.

In some aspects, a predictive expression can be developed based on the x parameter, species dissolved in the aqueous displacement fluid (prior to mixing with the resident water). Alternatively, a predictive expression can be based on the pH of the aqueous displacement fluid (prior to mixing with the resident water) as the pH is related to the x parameter. Thus, a predictive expression for the losses of dissolved monophosphate species in the aqueous displacement fluid can be based on the x parameter and/or the pH of the aqueous displacement fluid along with one or more chemical characteristics of the drive water, one or more physical characteristics of the reservoir, and the injected pore volume(s) of drive water. In some aspects, the predictive expression can also take the dispersivity of the reservoir and/or the initial concentration of dissolved monophosphate species in the aqueous displacement fluid into account.

As an example, a predictive expression used to determine the boundary values for the drive water composition can include the expression provided by Eq. 1 as used with the Weibull function of Eq. 2. As a further example, a predictive expression used to determine the boundary values for the drive water composition can include the expression provided by Eq. 3. Once the predictive expression (e.g. Eq. 1, and/or Eq. 3) are determined, one or more of the parameters can be fixed (e.g., held constant based on known or calculated values). In some aspects, the parameters that can be fixed can include, but are not limited to, a measured dispersivity and temperature of the reservoir into which it is intended to inject the aqueous displacement fluid, measured chemical characteristics of the aqueous displacement fluid, the injected pore volume of the drive water, and/or a permitted level of loss of dissolved monophosphate species. One or more values of the remaining variables can then be simulated to determine the boundary values for the chemical characteristics of the drive water that comply with the inputted upper limit for the permitted loss of dissolved monophosphate species.

A drive water having a composition with the chemical characteristics lying within the boundary values can then be selected and/or prepared for injection into the reservoir following injection of the slug of aqueous displacement fluid having the fixed chemical characteristics.

The simulations can be repeated using different permitted levels of loss of dissolved monophosphate species and, optionally, different predetermined pore volumes of drive water in order to optimize the boundary values for the chemical characteristics of the drive water such that a drive water may be selected having chemical characteristics that reduce losses of dissolved monophosphate species arising from dispersive mixing of the drive water with the slug of aqueous displacement fluid. The person skilled in the art will understand that the plurality of drive waters each have different chemical characteristics and each of the chemical characteristics that are inputted into the geochemical and statistical models can be independently varied within the models.

Where different waters having different chemical characteristics are available for use as the drive water, the predictive expression (e.g., Eq. 1 and/or Eq. 3 or any other suitable predictive expression) can determine which of the waters have chemical characteristics falling within the boundary conditions. Preferably, the predictive expression can be used to determine the optimal water for use as drive water, for example, the water having chemical characteristics falling within the narrowest of the boundary conditions (e.g., the boundary conditions having the lowest permitted loss of dissolved monophosphate species). In some aspects, selection of the water source for the drive water may also take other information into account such as cost, availability, and the like. Thus, the predictive expression developed according to the methods described herein may be used to select an available drive water that is predicted satisfy the selected permitted loss of dissolved monophosphate species upon dispersive mixing of the drive water with the aqueous displacement fluid at the rear of the injected slug of aqueous displacement fluid.

Suitably, the drive water may be selected from naturally occurring waters that are available at the injection site such as seawater, estuarine water, brackish water, produced water, saline aquifer waters, or mixtures thereof. Typically, such waters contain relatively high levels of precipitate precursor cations including calcium and magnesium cations. Alternatively, the drive water may be a naturally occurring water containing low levels of precipitate precursor cations such as river water or lake water. In the event that it is determined that use of the available naturally occurring water(s) as a drive water would exceed the permitted levels of loss of dissolved monophosphate species, it may be necessary to modify the chemical characteristics of the naturally occurring water, for example, by lowering the pH of the naturally occurring water by addition of an acid or by removing precipitate precursor cations by desalinating the naturally occurring water (for example, by passing the water through a reverse osmosis membrane) or by selectively removing the precipitate precursor cations (for example, by passing the water through a nanofiltration membrane that retains multivalent ions).

The losses of dissolved monophosphate species upon mixing of the aqueous displacement fluid with the resident water of the reservoir at the front of the aqueous displacement fluid may be modelled using any suitable geochemical model having a transportation mixing module, a speciation module and a precipitation module, for example, PHREEQC software, provided by the US Geological Survey (USGS) or Geochemist's Workbench provided by Aqueous Solutions LLC. Where a slug of the aqueous displacement fluid is injected into the reservoir, the geochemical model may also be used to model losses of dissolved monophosphate species upon dispersive mixing of a drive water with the aqueous displacement fluid at the rear of the slug. The person skilled in the art will understand that the geochemical model allows interactions between the mixing module, speciation module, and the precipitation module such that modelling of mixing, speciation and precipitation may be performed simultaneously in the model.

The mixing module of the geochemical model may be a batch type mixing module comprising a first cell, a second cell, and a third cell wherein a first volume of one of the plurality of different aqueous displacement fluids is inputted into the first cell, a second volume of one of the plurality of different resident waters or drive water is inputted into the second cell, and a fraction of the fluid contained in the first cell and a fraction of the fluid contained in the second cell are mixed within the third cell. The speciation and precipitation modules are then used to calculate the equilibrium concentrations of the dissolved monophosphate species in the resulting mixed fraction(s) at different reservoir conditions, for example different temperatures. The calculations may be repeated using different combinations of one of the plurality of different aqueous displacement fluids and one of the plurality different resident waters or drive waters. Thus, different fractions of the aqueous displacement fluid and of the resident water or drive water may be mixed in the batch system. The fractions of aqueous displacement fluid and resident water or drive water that are mixed in the third cell are determined using an inputted dispersivity value and an inputted fractional pore volume of aqueous displacement fluid.

Suitably, the mixing module may be a transportation mixing module, for example, a one-dimensional transportation mixing module or a three dimensional transportation mixing module. The one-dimensional transportation mixing module may be a single phase one-dimensional transportation mixing module. Suitably, the geochemical model comprises a one-dimensional transportation mixing module having a plurality of cells arranged in series through which fluids are shifted (displaced). The total number of cells in the series are taken to contain one pore volume of fluid. Accordingly, a fraction of the cells are taken to contain a fractional pore volume of fluid. When modelling injection of the aqueous displacement fluid, each of the cells of the series initially contain the resident water and, for each shift, the aqueous displacement fluid is introduced to the first cell in the series, fluids contained in the first and successive cells are shifted (displaced) to the next cell in the series, and fluids removed from the last cell in the series are disregarded. Thus, if there are n cells, introduction of one pore volume of aqueous displacement fluid into the cells will require n shifts. Typically, the number of cells, n, in the transportation mixing module is at least 10, preferably, 10 to 100. Mixing between the aqueous displacement fluid and the resident water is introduced as the aqueous displacement fluid advances through each cell of the series with the amount of mixing in each cell being determined from the inputted dispersivity value. Thus, mixing increases with both increasing dispersivity and with increasing injected pore volume of aqueous displacement fluid (e.g., with increasing number of shifts). For each shift, the speciation module and precipitation module are used to determine equilibrium losses of dissolved monophosphate species from one or more of the cells. The person skilled in the art will understand that as the fluids are shifted, the aqueous displacement fluid and resident water may become completely mixed in one of the cells of the series and consequently mixing of fluids may extend to other cells in the series.

Where transportation of a slug of aqueous displacement fluid is modelled using the series of cells, the size of the slug of aqueous displacement fluid is preferably selected such that a portion of the slug remains intact as the fluids are shifted through the cells of the series, e.g., the entire slug does not undergo dispersive mixing with either the resident water at the front of the slug or with the drive water at the rear of the slug. The person skilled in the art will understand that the minimum size of an “intact” slug will increase with increasing dispersivity. If modelling shows that the slug does not remain intact in the transportation module for the inputted value of dispersivity, the amount of aqueous displacement fluid introduced to the series of cells (i.e., the size of the slug) may be increased and transportation modelling may be repeated. The aqueous displacement fluid is added to the first cell in the series as the fluids are shifted (displaced) through successive cells in the series until the desired fractional pore volume of aqueous displacement fluid has been introduced to the series of cells. Thereafter, for each shift, drive water is introduced into the first cell in the series until the drive water has been shifted (displaced) through each of the cells in the series. Mixing between the drive water and aqueous displacement fluid is introduced as the aqueous displacement fluid advances through each cell of the series with the amount of mixing in each cell being determined from the inputted dispersivity value.

Typically, the speciation module of the geochemical model contains experimentally determined chemical equilibria for dissolved chemical species including both dissolved monophosphate species and dissolved non-phosphate species where the chemical equilibria are given as equations that are a function of temperature and pH. If necessary, additional experimentally determined chemical equilibria or chemical equilibria that are within the common general knowledge of the person skilled in the art, may be inputted into the speciation module such as chemical equilibria for hydrolysis of polyphosphate species.

Typically, the precipitation module of the geochemical model contains experimentally determined solubility equilibria for the chemical species wherein the solubility equilibria are given as equations that are a function of temperature and pH. In particular, the solubility equilibria include solubility equilibria for phosphate salts or phosphoric acids in the solid state in equilibria with aqueous solutions of the phosphate salts or phosphoric acids respectively and solubility equilibria for phosphate-containing minerals in the solid state in equilibria with aqueous solutions of the minerals.

Typically, the chemical species that are allowed to precipitate are specified in the precipitation module. These chemical species include water-insoluble phosphate salts of the precipitate precursor cations, phosphate minerals comprising the precipitate precursor cations and optionally other water-insoluble salts or minerals such as calcium carbonate, magnesium carbonate or carbonate minerals..It can be seen that the speciation module determines the chemical species that exist in aqueous solution at the modelled conditions while the precipitation module determines saturation values for these species and hence the losses of dissolved monophosphate species through precipitation of insoluble phosphate species under the modelled conditions.

The person skilled in the art will understand that the losses of dissolved monophosphate species can be determined as follows for each combination of fluids at the modelled conditions: [total phosphate precipitated from the modelled system]) / [total phosphate injected into the modelled system]

The losses of dissolved monophosphate species may be expressed as either a fraction or a percentage of the initial dissolved monophosphate species concentration of the aqueous displacement fluid, for example, as a mole fraction of a mole percentage. The losses of dissolved monophosphate species are based on the total moles of dissolved monophosphate species including moles of dissolved monophosphate species arising from a water-soluble monophosphate salt or an orthophosphoric acid or from hydrolysis of a water-soluble polyphosphate salt or a polyphosphoric acid.

The number of simulations that may be run using the geochemical model to generate the data inputted into the statistical model may be in excess of 1,000, in particular, in excess of 10,000, yet more particularly, in excess of 50,000, most particularly, in excess of 100,000.

The statistical model is used to determine correlations between losses of dissolved monophosphate species and (i) chemical characteristics of the aqueous displacement fluid, (ii) chemical characteristics of the resident water, (iii) physical characteristics of the reservoir such as dispersivity and temperature, and (iv) the injected pore volumes of aqueous displacement fluid thereby generating a predictive expression (e.g., such as Eq. 1 and/or Eq. 3, or any other suitable predictive expression).

Similarly, the statistical model may be used to determine correlations between losses of dissolved monophosphate species and (i) chemical characteristics of the aqueous displacement fluid, (ii) chemical characteristics of the drive water, (iii) physical characteristics of the reservoir such as dispersivity and temperature, and (iv) the injected pore volumes of drive water thereby determining the constants used in the predictive expression (e.g., such as Eq. 1 and/or Eq. 3, or any other suitable predictive expression).

In order to determine the predictive equation and/or the parameters or constants used in a predictive equation, an equation comprising arbitrary or random values for coefficients of a set of variable parameters that impact precipitation of insoluble phosphate species and hence losses of dissolved monophosphate species can be inputted into the statistical model. A multivariate optimization of this equation may be performed by the statistical model by adjusting values of one or more of the coefficients to give a modified (candidate) equation and comparing the output of the modified (candidate) equation to calculated losses of dissolved monophosphate species for the simulations performed using the geochemical model. The statistical model continues to the adjust one of more of the values of the coefficients to provide further modified (candidate) equations until an optimized equation is obtained that is a good fit for the calculated losses of dissolved monophosphate for the simulations performed using the geochemical model. Thus, during the optimization process, the losses of dissolved monophosphate species (e.g., the amount of precipitation of insoluble phosphate species) predicted by each modified (candidate) equation is compared against the geochemical modelling data and a sum of squared residuals (SSR) analysis may be performed to determine the extent to which the amount of precipitation of insoluble phosphate species (losses of dissolve phosphate) predicted by the modified (candidate) equation deviates from the calculated losses of dissolved monophosphate species determined from the geochemical simulations. Thus, an SSR analysis is a measure of the discrepancy between the losses of dissolved monophosphate species (e.g., amount of precipitation of insoluble phosphate species) predicted by the modified (candidate) equation and the losses of dissolved monophosphate species determined from the geochemical simulations. Accordingly, a small SSR is indicative of a good fit of the modified (candidate) equation to the geochemical modelling data. The statistical model therefore performs an iterative optimization of the equation by selecting one or more modified equations with small SSR values for further optimization. The optimized equations outputted by the statistical model are therefore the best of the modified (candidate) equations as they give the best fit to the geochemical modelling data sets. In order to define an operating envelope for the losses of dissolved monophosphate species arising from precipitation of insoluble phosphate species, Eq. 1 and/or Eq. 3 may be written in the form of an inequality defining a maximum permitted loss of dissolved monophosphate species.

Other ways of fitting an equation to the geochemical data may be employed such as other statistical analysis techniques or a genetic algorithm.

The modelled losses of dissolved monophosphate species may be history matched to measurement data obtained from laboratory experiments wherein different combinations of one of a plurality of different aqueous displacement fluids comprising aqueous solutions of at least one water-soluble inorganic phosphate salt and one of a plurality of different resident waters or drive waters comprising aqueous solutions of at least one salt of a precipitate precursor cation (such as a multivalent cation) are mixed together in different volumetric amounts and at different temperatures and wherein the resulting mixtures are analysed for dissolved monophosphate species content.

Geochemical modelling may be used to either determine boundary values for the chemical characteristics of the aqueous displacement fluid which, if obeyed, are predicted to give no precipitation of insoluble phosphate species or boundary values for the chemical characteristics of the aqueous displacement fluid which, if obeyed, would result in an acceptable loss of dissolved monophosphate species.

Different boundary values for the chemical characteristics of the aqueous displacement fluid may be determined for different inputted permitted levels of loss of dissolved monophosphate species, for example, 15%, 25%, or 50% (on a molar basis) loss of dissolved monophosphate species. The boundary values for the chemical characteristics of the aqueous displacement fluid may be determined for different fractional pore volumes of injected aqueous displacement fluid (for example, for 0.25, 0.5, 0.75, 1.0 or 2.0 pore volumes of injected aqueous displacement fluid).

Different boundary values for the chemical characteristics of the optional drive water may be determined for different inputted permitted levels of loss of dissolved monophosphate species, for example, 15%, 25%, or 50% (on a molar basis) loss of dissolved monophosphate species. The boundary values for the chemical characteristics of the drive water may be determined for different fractional pore volumes of injected drive water (for example, for 0.25, 0.5, 0.75, 1.0 or 2.0 pore volumes of injected drive fluid).

The person skilled in the art will understand that the boundary values for the aqueous displacement fluid and for the optional drive water narrow with decreasing permitted levels of loss of dissolved monophosphate species.

The person skilled in the art will understand that the pH of an aqueous displacement or drive fluid may be adjusted to lay within the boundary values. Thus, if the pH is too low, the pH may be increased through the addition of a base, for example, a Group IA metal hydroxide (for example, sodium hydroxide or potassium hydroxide) or ammonium hydroxide or, if the pH is too high, the pH may be decreased through the addition of an acid, for example, hydrochloric or hydrobromic acid. The use of sulphuric acid should be avoided owing to the risk of forming insoluble barium sulfate scale upon dispersive mixing of the aqueous displacement fluid with the resident water.

The water-soluble inorganic phosphate salt(s) used in the geochemical model include Group IA metal monophosphates, or ammonium monophosphates having varying ratios of Group IA metal counter-cations or ammonium counter-cations (M⁺) to hydrogen counter-cations (H⁺). The Group IA metal counter-cations may be selected from lithium, sodium, potassium, rubidium and caesium cations and are most preferably selected from sodium and potassium salts. The ammonium monophosphates counter-cations preferably have a general formula [NR¹R²R³R⁴]⁺ wherein R¹, R², R³, and R⁴ are independently selected from H or an alkyl group, in particular, methyl, ethyl, n-propyl, iso-propyl, n-butyl, iso-butyl and tert-butyl. Monophosphate salts used in the model may be selected from lithium dihydrogen phosphate (LiH₂PO₄), dilithium hydrogen phosphate (Li₂HPO₄), lithium phosphate (Li₃PO4), sodium dihydrogen phosphate (NaH₂PO₄), disodium hydrogen phosphate (Na₂HPO₄), sodium phosphate (Na₃PO₄), potassium dihydrogen phosphate (KH₂PO₄), dipotassium hydrogen phosphate (K₂HPO₄), potassium phosphate (K₃PO₄), rubidium dihydrogen phosphate (RbH₂PO₄), dirubidium hydrogen phosphate (Rb₂HPO₄), rubidium phosphate (Rb₃PO₄), caesium dihydrogen phosphate (CsH₂PO₄), dicaesium hydrogen phosphate (Cs₂HPO₄), caesium phosphate (Cs₃PO₄), ammonium dihydrogen phosphate ((NH₄)H₂PO₄)), ammonium hydrogen phosphate ((NH₄)₂HPO₄)), ammonium phosphate ((NH₄)₃PO₄)), tetramethylammonium dihydrogen phosphate ((NMe₄)H₂PO₄)), tetramethylammonium hydrogen phosphate ((NMe₄)₂HPO₄)), tetramethylammonium phosphate ((NMe₄)₃PO₄)), tetraethylammonium dihydrogen phosphate ((NEt₄)H₂PO₄)), tetraethylammonium hydrogen phosphate ((NEt₄)₂HPO₄)), tetraethylammonium phosphate ((NEt₄)₃PO₄)) and mixtures thereof.

In the case of water-soluble inorganic polyphosphate salts or polyphosphoric acids, the geochemical model assumes that the polyphosphate anions are hydrolysed to the thermodynamically controlled products of the hydrolysis reaction, typically, monophosphate anions. Thus, the inorganic polyphosphate salt or polyphosphate acid may be regarded as precursors of the monophosphate species.

The person skilled in the art will therefore understand that one or more water-soluble inorganic polyphosphate salts may be used as precursors of the monophosphate species. These precursors may be selected from a linear polyphosphate salt, a branched polyphosphate salt and a cyclic polyphosphate salt having varying ratios of monovalent counter-cations to hydrogen counter-cations. The linear polyphosphate salt may be a polyphosphate salt of general formula:

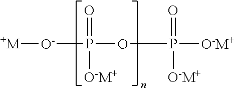

wherein n is an integer of from 1 to 4, preferably, 1 to 3, in particular, 1 or 2, and M⁺ represents a counter-cation selected from alkali metal cations, ammonium cations and optionally hydrogen cations. Preferred alkali metal counter-cations are Na⁺ or K⁺. Preferred ammonium counter-cations are of general formula [NR¹R²R³R⁴]⁺ where R¹, R², R³, and R⁴ are independently selected from H or an alkyl group, preferably, an alkyl group having from 1 to 10 carbon atoms, in particular, methyl, ethyl, propyl, and butyl. Preferred linear polyphosphates include pyrophosphates, tripolyphosphates, tetrapolyphosphates, and pentapolyphosphates.

The model also treats cyclic polyphosphates of general formula M⁺_{y}(PO₃⁻)_{y} wherein y is an integer from 3 to 8, in particular, 3 or 4, M⁺ is a monovalent counter-cation as defined above for the linear polyphosphates as precursors of monophosphate species. As an approximation, the value of x for such cyclic polyphosphates after hydrolysis to monophosphate species may be taken to be 1. Preferred cyclic polyphosphate salts that may be used as precursors of monophosphate species include trimetaphosphates, tetrametaphosphates, pentametaphosphates and hexametaphosphates. The value of the x parameter for the hydrolysed monophosphate product may be adjusted within the model by adjusting the pH.

Other inorganic polyphosphate salts that may be treated as precursors of monophosphate anions in the geochemical model include polydispersed mixtures of polyphosphates having the general formula M₍ₙ₊₂₎PₙO₍₃ₙ₊₁₎ where M is a monovalent counter-cation as defined above for the linear polyphosphates and n is the degree of polymerization. The polydispersed salt predominantly comprises linear unbranched polyphosphates although very low levels of cyclic polyphosphates may also be present in the salt. The degree of polymerization, n, has a polydispersed distribution with values of n ranging from 2 to 10⁶. The value of the x parameter for the hydrolysed monophosphate product may be adjusted within the model by adjusting the pH.

The geochemical model may be validated from core flood experiments performed using aqueous displacement fluids having chemical characteristics that lie within the boundary values and with aqueous displacement fluids having chemical characteristics that fall outside the boundary values. In each case, the geochemical model may be run at the temperature and pH of the core flood experiment using the compositions of the resident water and aqueous displacement fluid employed in the core flood experiment. The predicted loss of dissolved monophosphate species determined using the model may be compared with the measured loss of dissolved monophosphate species from the coreflood experiment wherein the loss of dissolved phosphate species is determined by comparing the dissolved monophosphate species concentration of the injected aqueous displacement fluid with the dissolved monophosphate species concentration of the aqueous effluent produced from the core sample.

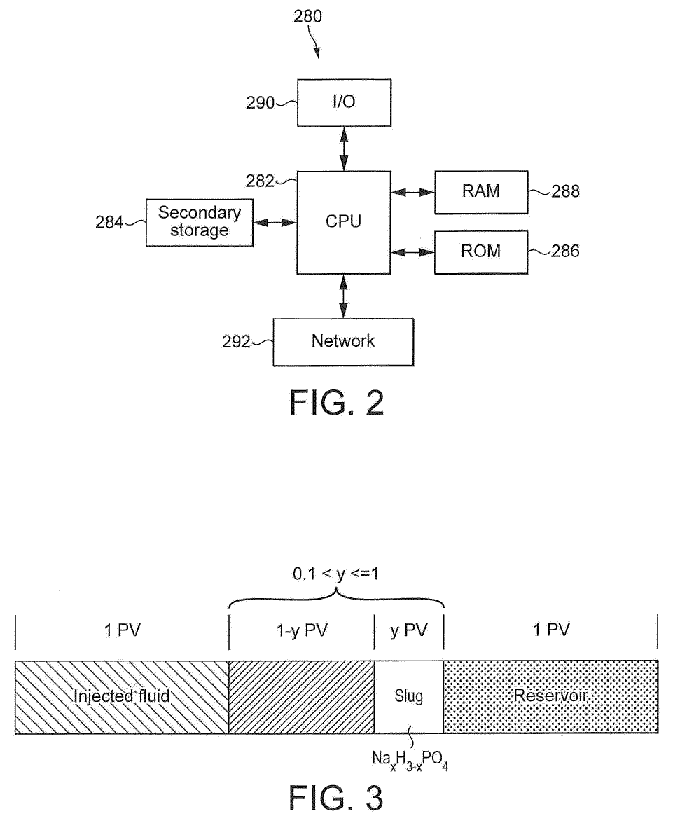

As described above, the modelling can be performed using a system with a geochemical model. In some aspects, the modeling can be performed using one or more processors in signal communication with a memory with the geochemical model (including the transportation mixing module, the speciation module, and the precipitation module) and/or one or more memories (e.g., one or more remote or local databases) storing laboratory or experimental data, historical test data, reservoir data, and the like. The modelling system and the associated methods disclosed herein can be carried out on a computer or other device comprising a processor. FIG. 2 illustrates a computer system 280 suitable for implementing one or more embodiments disclosed herein such as the acquisition device or any portion thereof. The computer system 280 includes a processor 282 (which may be referred to as a central processor unit or CPU) that is in communication with memory devices including secondary storage 284, read only memory (ROM) 286, random access memory (RAM) 288, input/output (I/O) devices 290, and network connectivity devices 292. The processor 282 may be implemented as one or more CPU chips.

It is understood that by programming and/or loading executable instructions onto the computer system 280, at least one of the CPU 282, the RAM 288, and the ROM 286 are changed, transforming the computer system 280 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 280 is turned on or booted, the CPU 282 may execute a computer program or application. For example, the CPU 282 may execute software or firmware stored in the ROM 286 or stored in the RAM 288. In some cases, on boot and/or when the application is initiated, the CPU 282 may copy the application or portions of the application from the secondary storage 284 to the RAM 288 or to memory space within the CPU 282 itself, and the CPU 282 may then execute instructions that the application is comprised of In some cases, the CPU 282 may copy the application or portions of the application from memory accessed via the network connectivity devices 292 or via the I/O devices 290 to the RAM 288 or to memory space within the CPU 282, and the CPU 282 may then execute instructions that the application is comprised of. During execution, an application may load instructions into the CPU 282, for example load some of the instructions of the application into a cache of the CPU 282. In some contexts, an application that is executed may be said to configure the CPU 282 to do something, e.g., to configure the CPU 282 to perform the function or functions promoted by the subject application. When the CPU 282 is configured in this way by the application, the CPU 282 becomes a specific purpose computer or a specific purpose machine.

The secondary storage 284 is typically comprised of one or more disk drives or tape drives and is used for non-volatile storage of data and as an over-flow data storage device if RAM 288 is not large enough to hold all working data. Secondary storage 284 may be used to store programs which are loaded into RAM 288 when such programs are selected for execution. The ROM 286 is used to store instructions and perhaps data which are read during program execution. ROM 286 is a non-volatile memory device which typically has a small memory capacity relative to the larger memory capacity of secondary storage 284. The RAM 288 is used to store volatile data and perhaps to store instructions. Access to both ROM 286 and RAM 288 is typically faster than to secondary storage 284. The secondary storage 284, the RAM 288, and/or the ROM 286 may be referred to in some contexts as computer readable storage media and/or non-transitory computer readable media.

I/O devices 290 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 292 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 292 may enable the processor 282 to communicate with the Internet or one or more intranets. With such a network connection, it is contemplated that the processor 282 might receive information from the network, or might output information to the network in the course of performing the above-described method steps. Such information, which is often represented as a sequence of instructions to be executed using processor 282, may be received from and outputted to the network, for example, in the form of a computer data signal embodied in a carrier wave.

Such information, which may include data or instructions to be executed using processor 282 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 282 executes instructions, codes, computer programs, scripts which it accesses from hard disk, floppy disk, optical disk (these various disk based systems may all be considered secondary storage 284), flash drive, ROM 286, RAM 288, or the network connectivity devices 292. While only one processor 282 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 284, for example, hard drives, floppy disks, optical disks, and/or other device, the ROM 286, and/or the RAM 288 may be referred to in some contexts as non-transitory instructions and/or non-transitory information.

In an embodiment, the computer system 280 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 280 to provide the functionality of a number of servers that is not directly bound to the number of computers in the computer system 280. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 280, at least portions of the contents of the computer program product to the secondary storage 284, to the ROM 286, to the RAM 288, and/or to other non-volatile memory and volatile memory of the computer system 280. The processor 282 may process the executable instructions and/or data structures in part by directly accessing the computer program product, for example by reading from a CD-ROM disk inserted into a disk drive peripheral of the computer system 280. Alternatively, the processor 282 may process the executable instructions and/or data structures by remotely accessing the computer program product, for example by downloading the executable instructions and/or data structures from a remote server through the network connectivity devices 292. The computer program product may comprise instructions that promote the loading and/or copying of data, data structures, files, and/or executable instructions to the secondary storage 284, to the ROM 286, to the RAM 288, and/or to other non-volatile memory and volatile memory of the computer system 280.

In some contexts, the secondary storage 284, the ROM 286, and the RAM 288 may be referred to as a non-transitory computer readable medium or a computer readable storage media. A dynamic RAM embodiment of the RAM 288, likewise, may be referred to as a non-transitory computer readable medium in that while the dynamic RAM receives electrical power and is operated in accordance with its design, for example during a period of time during which the computer system 280 is turned on and operational, the dynamic RAM stores information that is written to it. Similarly, the processor 282 may comprise an internal RAM, an internal ROM, a cache memory, and/or other internal non-transitory storage blocks, sections, or components that may be referred to in some contexts as non-transitory computer readable media or computer readable storage media.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims in any manner.

A number of simulations of mixing of an aqueous displacement fluids with resident waters were performed together with precipitation experiments to validate the simulations. The simulations were conducted to study the use of the operating envelope as described herein.

The simulations were carried out using PHREEQC geochemical modelling software and its one-dimensional transportation mixing module (version 3.2). The injection of various pore volumes (PV) of various aqueous displacement fluids (in the range of 0.001 to 1 PV) into a reservoir comprising various resident waters was modeled using the transportation mixing module (represented typically by 100 cells prefilled with a resident water) and at a plurality of different temperatures, and with a plurality of different pH values as well as with various dispersivity values. The low pore volume amounts of aqueous displacement fluid used in the simulations are hereinafter referred to as “slugs”. The modelling included the injection of slugs of various aqueous displacement fluids, each comprising a solution of a monophosphate salt in a low salinity water (LSSW) followed by the injection of the pure low salinity water (in the absence of the dissolved monophosphate salt). A constant Ca to Mg ratio was maintained in all injected aqueous fluids used in the simulations. However, the total dissolved solids content (TDS) and total divalent cations fraction (based on the TDS of the LSSW) in the aqueous displacement fluids and pure LSSW were varied.

FIG. 3 shows a scheme describing the design of the PHREEQC simulations. Table 1 contains a summary of all the parameters that were varied during the simulations. A total of 470,000 simulations were performed. Each simulation produced a separate file and used different sets of input parameters as well as various simulation settings. PHREEQC input and output data was processed by Python script. An integrated, standardized file with all of the output data was created. This integrated database file was then used as a basis for statistical analysis and predictive expression development.

TABLE 1

| | Variable/Calculated/ | |
|---|---|---|
| Parameter | Connate Dictionary | Relevant to |
| Total Dissolved Solids (TDS) | Variable | LSSW |
| in the LSSW (mg/kg of water) | | |
| Phosphate Salt concentration | Variable | slug |
| normalized to 1 PV (mg/kg of | | |
| water) | | |
| slug size (% PV) [indicated in | Variable | slug |
| FIG. 3 as parameter y] | | |
| pH resident water | Variable | reservoir |
| Temperature (° C.) | Variable | reservoir |
| Divalent cation concentration in | Variable | LSSW |
| the LSSW (mg/kg water) | | |
| Dispersivity (%) | Variable | reservoir |
| Y parameter | Variable | slug |
| Divalent cations in the LSSW | Variable | LSSW |
| (mass fraction of total dissolved | | |
| solids in the LSSW) | | |
| TDS concentration of the | Variable | reservoir |
| resident water (mg/kg water) | | |
| Divalent cation concentration | Variable | reservoir |
| of the resident water (mg/kg | | |
| water) | | |
| Initial monophosphate | Calculated | slug |
| concentration of aqueous | | |
| displacement fluid (mg/kg | | |
| water) | | |
| pH LSSW | Calculated | LSSW |
| pH of aqueous displacement | Calculated | slug |
| fluid | | |

The thermodynamic constants for phosphate species already contained in the PHREEQC database were derived using brines with significantly different compositions and phosphate concentrations to those that were to be modelled. As a result, a set of dedicated precipitation experiments were performed to confirm that the thermodynamic constants in the PHREEQC database were applicable to mixing of the modelled fluids.

The solutions used in the precipitation experiments were prepared using a synthetic seawater (SW) that was diluted with pure water to generate various LSSW compositions having different TDS and/or total divalent cation concentrations but each having the same Ca to Mg ratio.

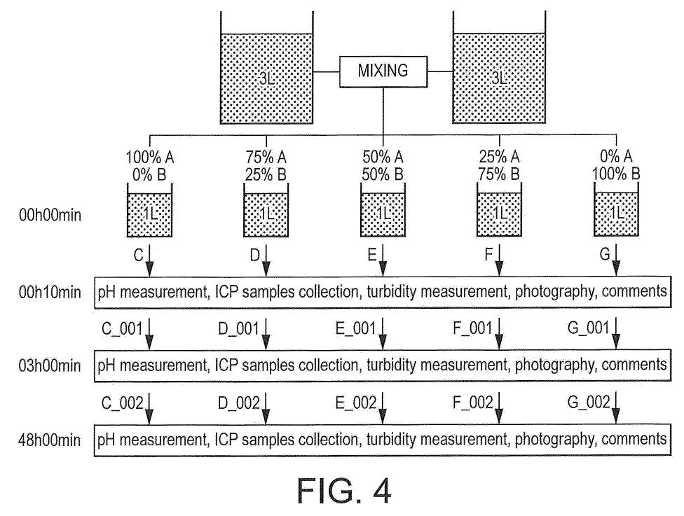

Five experiments were performed with two different resident waters (A and B) and with an aqueous displacement fluid containing 1000 ppm of monophosphate in LSSW. The pH values for the resident water and aqueous displacement fluid are given in Table 2. The resident waters and aqueous displacement fluid were then mixed in various proportions in order to represent a dispersion process that takes place in the reservoir. The experimental matrix is listed in Table 2, while the experimental procedure is schematically explained in FIG. 4.

TABLE 2

| Aqueous Displacement Fluid | Resident Water |
|---|---|
| LSSW + 1000 ppm monophosphate (pH 5) | Resident Water A (pH 6) |
| LSSW + 1000 ppm monophosphate (pH 5) | Resident Water A (pH 8) |
| LSSW + 1000 ppm monophosphate (pH 5) | Resident Water B (pH 5) |
| LSSW + 1000 ppm monophosphate (pH 5) | Resident Water B (pH 6) |
| LSSW + 1000 ppm monophosphate (pH 5) | Resident Water B (pH 7) |

In each experiment the resident water and aqueous displacement fluid were mixed in three ratios of 1:3, 1:1, and 3:1. Control samples of resident waters and aqueous displacement fluid were also retained for quality control (QC) purposes and in order to observe the extent of any pH drift. Turbidity and pH were measured for the mixed fluids and samples were taken 10 min, 3 hours, and 48 hours after mixing of the resident waters with the aqueous displacement fluid took place. Both filtered and unfiltered samples were taken and preserved using nitric acid. Samples were then analysed in the laboratory for all dissolved inorganic ions (e.g. phosphorus, sodium, calcium, magnesium, potassium) using Inductively Coupled Plasma-Mass Spectrometry (ICP-MS) and Ion Chromatography (IC).

High volumes of the mixtures of aqueous displacement fluid and resident water were used for each experiment (1 L) in order to minimize pH drift and brine degassing. All experiments were carried out at room temperature 21° C. without additional atmospheric control (bottles were sealed and the volume of gas above the liquid level was minimized).

The results of the precipitation experiments were then compared to the predicted precipitation behavior for the mixed fluid obtained using PREEQC. The results indicated that PREEQC can predict precipitation of insoluble phosphate species and changes in solution properties upon mixing of the aqueous displacement fluid with the resident water (e.g., pH changes) at ambient conditions for monophosphate species with a good degree of accuracy.

Basic analysis of the data set outputted from PREEQC demonstrated that precipitation of insoluble phosphate species is closely correlated with the x parameter (as defined above). Precipitation of insoluble phosphate species is also closely correlated with the pH value of the injected aqueous displacement fluid although the correlation is not as strong as for the x parameter. However, both parameters (x and pH) are correlated with each other. Dispersivity of the reservoir and the initial concentration of the monophosphate species in the aqueous displacement fluid were also found to be correlated with loss of dissolved monophosphate species through precipitation of insoluble phosphate species.

The model results were used according to the methods described herein to develop the relationship in Eq. 1 and Eq. 2 (given above). The RMSE (Residual Mean Square Error) of 6.8 was estimated for the predictive expression defined by Eq. 1. The values of the constants in Eq. 1 were determined using the data outputted from PHREEQC, where: a has a value of 0.002164, b has a value of 0.000023699, c has a value of 0.3, d has a value of 901.43, e has a value of 34490.0, f has a value of 25.378, g has a value of 0.64178, h has a value of −404.297, i has a value of 0.083218, j has a value of −0.0041599, k has a value of −1, and 1 has a value of 1.5. Thus, the methods and systems can be used to determine the predictive expression, which can further be used to determine the operating envelope for the aqueous displacement fluid.

Similarly, the model results were used according to the methods described herein to develop the relationship in Eq. 3 (given above). The RMSE (Residual Mean Square Error) of 10.8 was estimated for the predictive expression defined by Eq. 3. The values of the constants in Eq. 3 were determined using the data outputted from PHREEQC, where: a has a value of 0.00893358577866, b has a value of 0.00001873911362, c has a value of 0.3, d has a value of −38.760711942606, e has a value of 36612.4690660208, f has a value of 22.3005918895281, g has a value of 5.70150711512329, h has a value of −511.4406033857, i has a value of 0.14791108670263, j has a value of −0.028208361561 and k has a value of −2.6106766395516. Thus, the methods and systems can be used to determine a predictive expression, which can further be used to determine the operating envelope for the aqueous displacement fluid. Having described various systems and methods herein, various aspects of can include, but are not limited to:

In a first aspect, a computer-implemented method for determining a composition of an aqueous displacement fluid for injection into a subterranean reservoir comprising at least one layer of a porous and permeable reservoir rock having crude oil and a resident water in a pore space thereof comprises: modelling a plurality of mixtures formed by mixing of each of a plurality of aqueous displacement fluids with one or more resident water compositions for one or more reservoirs, wherein each aqueous displacement fluid comprises an aqueous solution comprising dissolved phosphate species, wherein the one or more resident water compositions comprise at least one water-soluble precursor cation species for insoluble phosphate species, and wherein the one or more reservoirs have one or more physical characteristics; generating data indicative of losses of dissolved phosphate species in each mixture of the plurality of mixtures wherein the losses are determined using the one or more physical characteristics of the one or more reservoirs; determining one or more correlations between (i) the losses of dissolved phosphate species and (ii) chemical characteristics of the aqueous displacement fluid, chemical characteristics of the one or more resident water compositions, and the one or more physical characteristics of the one or more reservoirs; determining a predictive expression for losses of dissolved phosphate species based on the one or more correlations; and determining boundary values for the chemical characteristics of the aqueous displacement fluid for selected chemical characteristics of the one or more resident water compositions and selected physical characteristics of the reservoir using the predictive expression.

A second aspect can include the method of the first aspect, wherein the physical characteristics of the one or more reservoirs comprise: dispersivity, temperature, or any combination thereof.

A third aspect can include the method of the first or second aspect, wherein the chemical characteristics of the aqueous displacement fluid comprise an initial multivalent cation concentration, an initial concentration of dissolved phosphate species, a pH, an average number of hydrogens in the dissolved phosphate species, or any combination thereof.

A fourth aspect can include the method of any of the first to third aspects, wherein the chemical characteristics of the one or more resident water compositions comprise a pH, a multivalent cation concentration, a divalent cation concentration, the concentration of one or more individual multivalent cations, or any combination thereof

A fifth aspect can include the method of any of the first to fourth aspects, further comprising: selecting an aqueous displacement fluid having chemical characteristics within the boundary values for a reservoir having a defined composition of resident water and defined physical characteristics, wherein the selected aqueous displacement fluid is injected into the reservoir.

A sixth aspect can include the method of any of the first to fifth aspects, wherein the aqueous displacement fluid comprises an aqueous solution of dissolved monophosphate species having an average formula [H₃₋ₓPO₄]^{x-}, wherein the value of x is between about 0 and about 3.

A seventh aspect can include the method of any of the first to sixth aspects, wherein the modelling of the mixing is performed after injection of a selected pore volume (PV) of the aqueous displacement fluid into the one or more reservoirs and the determining of the one or more correlations further comprises determining correlations between the losses of dissolved phosphate species and the selected pore volume of injected aqueous displacement fluid.

An eighth aspect can include the method of the seventh aspect, wherein the selected pore volume is in the range of about 0.3 to about 0.7.

A ninth aspect can include the method of any of the first to eighth aspects, wherein the predictive expression predicts a loss of dissolved phosphate species arising from precipitation of insoluble phosphate species based on: a multivalent cation concentration of the aqueous displacement fluid, a pH of the resident water, a multivalent cation concentration of the resident water, a dispersivity of the reservoir, an initial concentration of the dissolved phosphate species in the aqueous displacement fluid, and parameter x (i.e., the missing hydrogens in the average formula [H₃₋ₓPO₄]⁻ for dissolved monophosphate species in the aqueous displacement fluid), a pH of the aqueous displacement fluid, or both the x parameter and the pH of the aqueous displacement fluid.

A tenth aspect can include the method of any of the seventh to ninth aspects, wherein the initial concentration of dissolved monophosphate species for the selected injected pore volume, [monophosphate]_{selected injected PV}, is normalized to an initial average dissolved monophosphate species concentration in one pore volume, [monophosphate]ₒₙₑ Pv, as follows: [monophosphate]_{selected injected PV}=[monophosphate]_{1 PV}/selected PV.

In an eleventh aspect, a method for selecting an aqueous displacement fluid comprising an aqueous solution of dissolved phosphate species comprises: obtaining one or more reservoir parameters for a reservoir, wherein the reservoir comprises a porous and permeable rock having crude oil and a resident water in a pore space thereof and wherein the reservoir parameters comprise physical characteristics of the reservoir and chemical characteristics of the resident water; receiving an input comprising a permitted loss of dissolved phosphate species resulting from mixing of the aqueous displacement fluid and resident water within the reservoir following injection of a selected pore volume of the aqueous displacement fluid into the reservoir; selecting an aqueous displacement fluid; and determining that a composition of the aqueous displacement fluid is within an operating envelope using one or more inputs comprising the one or more reservoir parameters and the permitted loss of dissolved phosphate species, wherein the operating envelope defines boundary conditions for one or more parameters of the composition of the aqueous displacement fluid to limit a loss of dissolved phosphate species through precipitation of insoluble phosphate species from the aqueous displacement fluid upon injection of the selected pore volume of aqueous displacement fluid into the reservoir to less than or equal to the permitted loss of dissolved phosphate species.

A twelfth aspect can include the method of the eleventh aspect, wherein the one or more reservoir parameters comprise physical characteristics selected from a dispersivity of the reservoir, a temperature of the reservoir, or any combination thereof

A thirteenth aspect can include the method of the eleventh or twelfth aspect, wherein the one or more reservoir parameters comprise chemical characteristics of the resident water selected from pH, multivalent cation concentration, the concentration of one or more individual multivalent cations, or any combination thereof.

A fourteenth aspect can include the method of any of the eleventh to thirteenth aspects, wherein the one or more parameters of the composition of the aqueous displacement fluid comprise an initial multivalent cation concentration, an initial concentration of dissolved phosphate species, the x parameter, a pH or any combination thereof.

A fifteenth aspect can include the method of any of the eleventh to fourteenth aspects, wherein determining that the composition of the aqueous displacement fluid composition is within the operating envelope comprises using one or more of the chemical characteristics of the resident water in the reservoir.

A sixteenth aspect can include the method of any of the eleventh to fifteenth aspects, wherein the aqueous displacement fluid is injected into the reservoir

In a seventeenth aspect, a method of injecting a fluid comprises: injecting an aqueous displacement fluid into a subterranean reservoir, wherein the subterranean reservoir comprises a porous and permeable rock having crude oil and a resident water in a pore space thereof, wherein the resident water comprising a multivalent cation species, wherein the resident water has a pH and a multivalent cation concentration, and wherein the subterranean formation has a dispersivity; wherein the aqueous displacement fluid comprises an initial multivalent cation concentration, and an initial additive concentration of dissolved phosphate species normalized to one pore volume; and limiting precipitation of the dissolved phosphate species upon mixing of the aqueous displacement fluid with the resident water within the subterranean reservoir to less than or equal to a predetermined amount, wherein a percentage of precipitation of the dissolved phosphate species arising from precipitation of insoluble phosphate species, after injection of from 0.3 to 0.7 pore volumes of aqueous displacement fluid, is defined by:

$$\frac{( \begin{matrix}( \begin{matrix}( a * ( DL ) + d ) + b * \\ ( PC + f ) * ( DC + e ) * \\ {( i * DP [ \% ] + j )}^{c}\end{matrix} ) * \\ AC * WD ( x + k , l )\end{matrix} )}{g * ( AC + h )}$$

wherein DL is the multivalent cation concentration of the aqueous displacement fluid in units of (mg/kg of water), PC is the pH of the resident water, DC is the multivalent cation concentration of the resident water in units of (mg/kg of water), DP is a dispersivity of the subterranean formation in units of (%), AC is the initial concentration of the dissolved phosphate species normalized to one pore volume, and WD is a Weibull function of a parameter x, wherein x is the number of missing hydrogens in the average formula [H₃₋ₓPO₄]^{x-}, wherein a has a value of 0.002164, b has a value of 0.000023699, c has a value of 0.3, d has a value of 901.43, e has a value of 34490.0, f has a value of 25.378, g has a value of 0.64178, h has a value of −404.297, i has a value of 0.083218, j has a value of −0.0041599, k has a value of −1, and 1 has a value of 1.5

An eighteenth aspect can include the method of the seventeenth aspect, wherein the dissolved phosphate species in the aqueous displacement fluid have an average formula of [H₃₋ₓ P)₄]^{x-}, where a value of x is between 0 and 3.

A nineteenth aspect can include the method of the seventeenth or eighteenth aspect, wherein the Weibull function is defined by:

$$f ( x ; λ , k ) = \{ \begin{matrix}\frac{k}{λ} {( \frac{x}{λ} )}^{k - 1} {e}^{- {( x / λ )}^{k}} , & x \geq 0 \\ 0 , & x < 0\end{matrix}$$

A twentieth aspect can include the method of any of the seventeenth to nineteenth aspects, wherein the dissolved phosphate species are derived from a phosphate salt having an average formula of Mₓ[H₃₋ₓPO]^{x-}, wherein M is a monovalent cation.

A twenty first aspect can include the method of the twentieth aspect, wherein M is a monovalent cation comprising a Group IA metal cation, an ammonium cation, or any combination thereof.

A twenty second aspect can include the method of any of the seventeenth to twenty first aspects, wherein the multivalent cation species in the resident water is a phosphate precipitate precursor cation.

A twenty third aspect can include the method of any of the seventeenth to twenty second aspects, wherein the multivalent cation species in the resident water comprises a calcium cation, a magnesium cation, a barium cation, an iron cation, a strontium cation, a vanadium cation, an aluminum cation, an iron cation, or any combination thereof.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure.

1. A computer-implemented method for determining a composition of an aqueous displacement fluid for injection into a subterranean reservoir comprising at least one layer of a porous and permeable reservoir rock having crude oil and a resident water in a pore space thereof, the method comprising:
modelling a plurality of mixtures formed by mixing of each of a plurality of aqueous displacement fluids with one or more resident water compositions for one or more reservoirs, wherein each aqueous displacement fluid comprises an aqueous solution comprising dissolved phosphate species, wherein the one or more resident water compositions comprise at least one water-soluble precursor cation species for insoluble phosphate species, and wherein the one or more reservoirs have one or more physical characteristics;
generating data indicative of losses of dissolved phosphate species in each mixture of the plurality of mixtures wherein the losses are determined using the one or more physical characteristics of the one or more reservoirs;
determining one or more correlations between (i) the losses of dissolved phosphate species and (ii) chemical characteristics of the aqueous displacement fluid, chemical characteristics of the one or more resident water compositions, and the one or more physical characteristics of the one or more reservoirs;
determining a predictive expression for losses of dissolved phosphate species based on the one or more correlations through precipitation of insoluble phosphate species from the aqueous displacement fluid upon injection of a selected pore volume of aqueous displacement fluid into the reservoir; and
determining boundary values for the chemical characteristics of the aqueous displacement fluid for selected chemical characteristics of the one or more resident water compositions and selected physical characteristics of the reservoir using the predictive expression, wherein the boundary values for the chemical characteristics limit a loss of the dissolved phosphate species through the precipitation of the insoluble phosphate species from the aqueous displacement fluid upon injection of the selected pore volume of the aqueous displacement fluid into the reservoir to less than or equal to a permitted loss of dissolved phosphate species.

2. The method of claim 1, wherein the physical characteristics of the one or more reservoirs comprise: dispersivity, temperature, or any combination thereof.

3. The method of claim 1, wherein the chemical characteristics of the aqueous displacement fluid comprise an initial multivalent cation concentration, an initial concentration of dissolved phosphate species, a pH, an average number of hydrogens in the dissolved phosphate species, or any combination thereof.

4. The method of claim 1, wherein the chemical characteristics of the one or more resident water compositions comprise a pH, a multivalent cation concentration, a divalent cation concentration, the concentration of one or more individual multivalent cations, or any combination thereof.

5. The method of claim 1, further comprising: selecting an aqueous displacement fluid having chemical characteristics within the boundary values for a reservoir having a defined composition of resident water and defined physical characteristics, wherein the selected aqueous displacement fluid is injected into the reservoir.

6. The method of claim 1, wherein the aqueous displacement fluid comprises an aqueous solution of dissolved monophosphate species having an average formula [H₃₋ₓPO₄]^{x-}, wherein the value of x is between about 0 and about 3.

7. The method of claim 1, wherein the modelling of the mixing is performed after injection of a selected pore volume (PV) of the aqueous displacement fluid into the one or more reservoirs and the determining of the one or more correlations further comprises determining correlations between the losses of dissolved phosphate species and the selected pore volume of injected aqueous displacement fluid.

8. The method of claim 7, wherein the selected pore volume is in the range of about 0.3 to about 0.7.

9. The method of claim 1, wherein the predictive expression predicts a loss of dissolved phosphate species arising from precipitation of insoluble phosphate species based on: a multivalent cation concentration of the aqueous displacement fluid, a pH of the resident water, a multivalent cation concentration of the resident water, a dispersivity of the reservoir, an initial concentration of the dissolved phosphate species in the aqueous displacement fluid, and the parameter, x, defined as missing hydrogens in the average formula [H₃₋ₓPO₄]^{x-} for dissolved monophosphate species (or the valency of the average formula [H₃₋ₓPO₄]^{x-} for dissolved monophosphate species) in the aqueous displacement fluid, a pH of the aqueous displacement fluid, or both the parameter x and the pH of the aqueous displacement fluid.

10. The method of claim 9, wherein the initial concentration of dissolved monophosphate species for the selected injected pore volume, [monophosphate]_{selected injected PV}, is normalized to an initial average dissolved monophosphate species concentration in one pore volume, [monophosphate]_{one PV,} as follows:
[monophosphate]_{selected injected PV}=[monophosphate]_{1 PV}/selected PV.

11. A method for selecting an aqueous displacement fluid comprising an aqueous solution of dissolved phosphate species, the method comprising:
obtaining one or more reservoir parameters for a reservoir, wherein the reservoir comprises a porous and permeable rock having crude oil and a resident water in a pore space thereof and wherein the reservoir parameters comprise physical characteristics of the reservoir and chemical characteristics of the resident water;
receiving an input comprising a permitted loss of dissolved phosphate species resulting from mixing of the aqueous displacement fluid and resident water within the reservoir following injection of a selected pore volume of the aqueous displacement fluid into the reservoir;
selecting an aqueous displacement fluid; and
determining that a composition of the aqueous displacement fluid is within an operating envelope using one or more inputs comprising the one or more reservoir parameters and the permitted loss of dissolved phosphate species, wherein the operating envelope defines boundary conditions for one or more parameters of the composition of the aqueous displacement fluid to limit a loss of dissolved phosphate species through precipitation of insoluble phosphate species from the aqueous displacement fluid upon injection of the selected pore volume of aqueous displacement fluid into the reservoir to less than or equal to the permitted loss of dissolved phosphate species.

12. The method of claim 11, wherein the one or more reservoir parameters comprise physical characteristics selected from a dispersivity of the reservoir, a temperature of the reservoir, or any combination thereof.

13. The method of claim 11, wherein the one or more reservoir parameters comprise chemical characteristics of the resident water selected from pH, multivalent cation concentration, the concentration of one or more individual multivalent cations, or any combination thereof.

14. The method of claim 11, wherein the one or more parameters of the composition of the aqueous displacement fluid comprise an initial multivalent cation concentration, an initial concentration of dissolved phosphate species, missing hydrogens, x, in the average formula [H₃₋ₓPO₄]^{x-}, a pH or any combination thereof.

15. The method of claim 11, wherein determining that the composition of the aqueous displacement fluid composition is within the operating envelope comprises using one or more of the chemical characteristics of the resident water in the reservoir.

16. The method of claim 11, wherein the aqueous displacement fluid is injected into the reservoir.

17. A method of injecting a fluid comprising:
injecting an aqueous displacement fluid into a subterranean reservoir, wherein the subterranean reservoir comprises a porous and permeable rock having crude oil and a resident water in a pore space thereof, wherein the resident water comprising a multivalent cation species, wherein the resident water has a pH and a multivalent cation concentration, and wherein the subterranean formation has a dispersivity;
wherein the aqueous displacement fluid comprises an initial multivalent cation concentration, and an initial additive concentration of dissolved phosphate species normalized to one pore volume; and
limiting precipitation of the dissolved phosphate species upon mixing of the aqueous displacement fluid with the resident water within the subterranean reservoir to less than or equal to a predetermined amount, wherein a percentage of precipitation of the dissolved phosphate species arising from precipitation of insoluble phosphate species, after injection of from 0.3 to 0.7 pore volumes of aqueous displacement fluid, is defined by:
$$\frac{( \begin{matrix}( \begin{matrix}( a * ( DL ) + d ) + b * \\ ( PC + f ) * ( DC + e ) * \\ {( i * DP [ \% ] + j )}^{c}\end{matrix} ) * \\ AC * WD ( x + k , l )\end{matrix} )}{g * ( AC + h )}$$
wherein DL is the multivalent cation concentration of the aqueous displacement fluid in units of (mg/kg of water), PC is the pH of the resident water, DC is the multivalent cation concentration of the resident water in units of (mg/kg of water), DP is a dispersivity of the subterranean formation in units of (%), AC is the initial concentration of the dissolved phosphate species normalized to one pore volume, and WD is a Weibull function of a parameter x, wherein x is a number in the range of 0 to 3 for the number of missing hydrogens in the average formula [H₃₋ₓPO₄]^{x-} (or x is the valency of the average formula [H₃₋ₓPO₄]⁻), wherein a has a value of 0.002164, b has a value of 0.000023699, c has a value of 0.3, d has a value of 901.43, e has a value of 34490.0, f has a value of 25.378, g has a value of 0.64178, h has a value of −404.297, i has a value of 0.083218, j has a value of −0.0041599, k has a value of −1, and / has a value of 1.5.

18. The method of claim 17, wherein the Weibull function is defined by:
$$f ( x ; λ , k ) = \{ \begin{matrix}\frac{k}{λ} {( \frac{x}{λ} )}^{k - 1} {e}^{- {( x / λ )}^{k}} , & x \geq 0 \\ 0 , & x < 0\end{matrix}$$

19. A method of injecting a fluid comprising:
injecting an aqueous displacement fluid into a subterranean reservoir, wherein the subterranean reservoir comprises a porous and permeable rock having crude oil and a resident water in a pore space thereof, wherein the resident water comprising a multivalent cation species, wherein the resident water has a pH and a multivalent cation concentration, and wherein the subterranean formation has a dispersivity;
wherein the aqueous displacement fluid comprises an initial multivalent cation concentration, and an initial additive concentration of dissolved phosphate species normalized to one pore volume; and
limiting precipitation of the dissolved phosphate species upon mixing of the aqueous displacement fluid with the resident water within the subterranean reservoir to less than or equal to a predetermined amount, wherein a percentage of precipitation of the dissolved phosphate species arising from precipitation of insoluble phosphate species, after injection of from 0.3 to 0.7 pore volumes of aqueous displacement fluid, is defined by:
$$\% of phosphate lost = \frac{( \begin{matrix}( \begin{matrix}( a * ( DL ) + d ) + b * \\ ( PC + f ) * ( DC + e ) * \\ {( i * DP [ \% ] + j )}^{c}\end{matrix} ) * \\ AC * ( pH + k )\end{matrix} )}{g * ( AC + h )} \qquad ( Eq . 3 )$$
where DL is the multivalent cation concentration of the aqueous displacement fluid in units of (mg/kg of water), PC is the pH of the resident water, DC is the multivalent cation concentration of the resident water in units of (mg/kg of water), DP is a dispersivity of the subterranean formation in units of (%), AC is the initial concentration of the dissolved phosphate species normalized to one pore volume and pH is the pH of the aqueous displacement fluid and wherein a has a value of 0.00893358577866, b has a value of 0.00001873911362, c has a value of 0.3, d has a value of −38.760711942606, e has a value of 36612.4690660208, f has a value of 22.3005918895281, g has a value of 5.70150711512329, h has a value of −511.4406033857, i has a value of 0.14791108670263, j has a value of −0.028208361561 and k has a value of −2.6106766395516.

20. The method of claim 19, wherein the dissolved phosphate species are derived from a phosphate salt having an average formula of Mₓ[H₃₋ₓPO₄]^{x-}, wherein M is a monovalent cation comprising a Group IA metal cation, an ammonium cation, or any combination thereof.

21. The method of claim 19, wherein the multivalent cation species in the resident water is a phosphate precipitate precursor cation comprising a calcium cation, a magnesium cation, a barium cation, an iron cation, a strontium cation, a vanadium cation, an aluminum cation, an iron cation, or any combination thereof.

22. The method of claim 17, wherein the dissolved phosphate species are derived from a phosphate salt having an average formula of Mₓ[H₃₋ₓPO₄]^{x-}, wherein M is amonovalent cation comprising a Group IA metal cation, an ammonium cation, or any combination thereof.

23. The method of claim 17, wherein the multivalent cation species in the resident water is a phosphate precipitate precursor cation comprising a calcium cation, a magnesium cation, a barium cation, an iron cation, a strontium cation, a vanadium cation, an aluminum cation, an iron cation, or any combination thereof.
